(19) United States
(12) Patent Application Publication
(10) Pub. No.: US 2018/0003293 A1
(43) Pub. Date: Jan. 4, 2018

(54) GEAR UNIT FOR MOTOR VEHICLE

(71) Applicant: Ford Global Technologies, LLC, Dearborn, MI (US)

(72) Inventors: Michael Georg Figura, Dormagen (DE); Armin Schymczyk, Solingen (DE); Alexander Ein Waldt, Köln (DE)

(73) Assignee: Ford Global Technologies, LLC, Dearborn, MI (US)

(21) Appl. No.: 15/636,334

(22) Filed: Jun. 28, 2017

(30) Foreign Application Priority Data
Jun. 29, 2016 (DE) DE102016211714.9

(51) Int. Cl. F16H 57/12; F16H 1/16; F16H 57/021; B62D 5/04

(52) U.S. Cl. CPC F16H 57/12; F16H 57/021; F16H 1/16; B62D 5/04; F16H 2057/0213; F16H 2057/127

(57) ABSTRACT

A gear unit for a motor vehicle having a rotary bearing supporting a worm gear shaft, rotatable about an axially extending rotation axis, on a housing. The rotary bearing pivotable about a pivot axis and includes a spherical outer face and a stationary pivot ring. The gear unit includes a spring element extending tangentially or circumferentially, at least partially, around the rotation axis, and positioned such that one side engages the housing and the other side, through two axially protruding contact portions lying opposite each other in the direction of the pivot axis, engages the rotary bearing. The spring element includes a ring portion extending transversely to the axial direction and tangentially, at least partially, around the rotation axis.

### CROSS-REFERENCE TO RELATED APPLICATIONS

Not Applicable.

### BACKGROUND OF THE INVENTION

### 1. Field of the Invention

The present invention relates generally to a gear unit for a motor vehicle; and more particularly to a gear unit having a worm gear shaft supported on a housing by a pivotable rotary bearing.

### 2. Description of Related Art

Modern motor vehicles are usually equipped with power-assisted steering to considerably reduce the effort to turn the steered wheels during driving and, when stopped or moving slowly. Power steering can also provide feedback of forces acting on the steered wheels and may generate a particular steering moment to provide the driver with a recommended steering movement. Both hydraulic and motorized power steering systems are used. With a motorized power steering system, an electric servo motor with a drive shaft acts on a worm gear shaft, which acts on a worm gear wheel. The worm gear wheel sits on the steering shaft, which acts through a pinion on a steering rack. Similar systems having a servo motor, worm gear shaft, and worm gear wheel are also used in other areas of motor vehicles, for example, window lifters.

Although theoretically, under ideal conditions, an optimum engagement with the worm gear wheel is possible with a worm gear shaft rotating around a fixed axis, in practice, engagement may deteriorate due to production-induced or installation-induced inaccuracies, wear effects, soiling, and environmental influences such as moisture and temperature. The above influences, alone or in combination, may lead to the engagement between the worm gear shaft and worm gear wheel being too loose and/or too tight. Too tight an engagement is a problem since it leads to increased friction, makes the gears difficult to move, and increases wear.

One method known for alleviating such problems is to mount the worm gear shaft, on a side facing the drive shaft, with a first roller bearing, normally a ball bearing, that allows tilt or pivot movement transversely to the axial direction of the worm gear shaft. A second roller bearing, normally a ball bearing, mounts the opposite side of the worm gear shaft to a gear housing or structure through a spring. The spring exerts a bias, applies a load, on the worm gear shaft, in the direction of the worm gear wheel. The worm gear shaft pivots about the first roller bearing to remain in approximately constant engagement with the worm gear wheel.

One disadvantage is that the pivotability is usually only possible through a greater play in the region of the first roller bearing, leading to the possibility of vibrations and associated rattling noises, which are undesirable NVH aspects. The precision of the gear mechanism is also adversely affected because the axial and radial position of the worm gear shaft cannot be set precisely in the region of the first roller bearing. If bearing play is reduced in the region of the roller bearing, it usually leads to increased friction detracting from precision of control and leading to increased wear. Offsetting the action line of the force resulting from the engagement with the worm gear wheel on the worm gear shaft, towards the center axis of the latter, leads to a different level of friction and gear efficiency depending on the rotation direction of the worm gear shaft. This allows a degree of pivotability without the actual roller bearing needing unnecessary play, but the pivot axis is not defined precisely because of the structure of the pivot bearing. Also, the stiffness of the system against axial displacements is low and cannot be set in a targeted fashion. This in turn adversely affects the precision of the gear mechanism, and the engagement of the worm gear shaft with the worm gear wheel is not optimal. If engagement of the toothing under load is not optimal corresponding gear play leads to audible and undesirable clattering noise.

### SUMMARY OF THE INVENTION

A gear unit for a motor vehicle including a housing, a worm gear shaft rotatable about a rotation axis and a rotary bearing mounting the worm gear shaft on the housing. The gear unit also includes a spring element located between the rotary bearing and the housing with the spring element having a ring portion, two axially protruding contact portions opposite each other in the direction of a pivot axis, two spring portions, and a positioning element.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagrammatic, partial cross-sectional view depicting a gear unit according to a first embodiment of the invention.

FIG. 2 is a diagrammatic, partial cross-sectional top view, in the direction II, of the gear unit of FIG. 1.

FIG. 3 is a side view of a spring element of the gear unit of FIG. 1.

FIG. 4 is a partial cross-sectional view, taken along lines 4-4 of FIG. 3 including an outer bearing ring of a ball bearing.

### DETAILED DESCRIPTION OF THE PREFERRED EMBODIMENTS

The following description of the preferred embodiment(s) is merely exemplary in nature and is in no way intended to limit the invention, its application, or uses. In the different figures, identical parts are always provided with the same reference signs, and so said parts are generally also described only once.

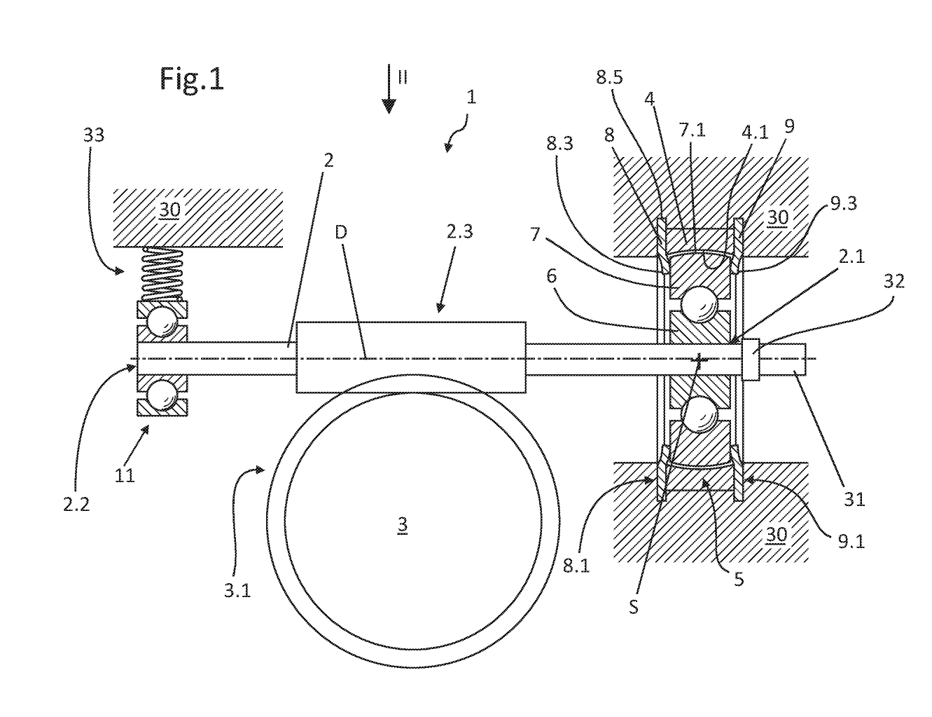

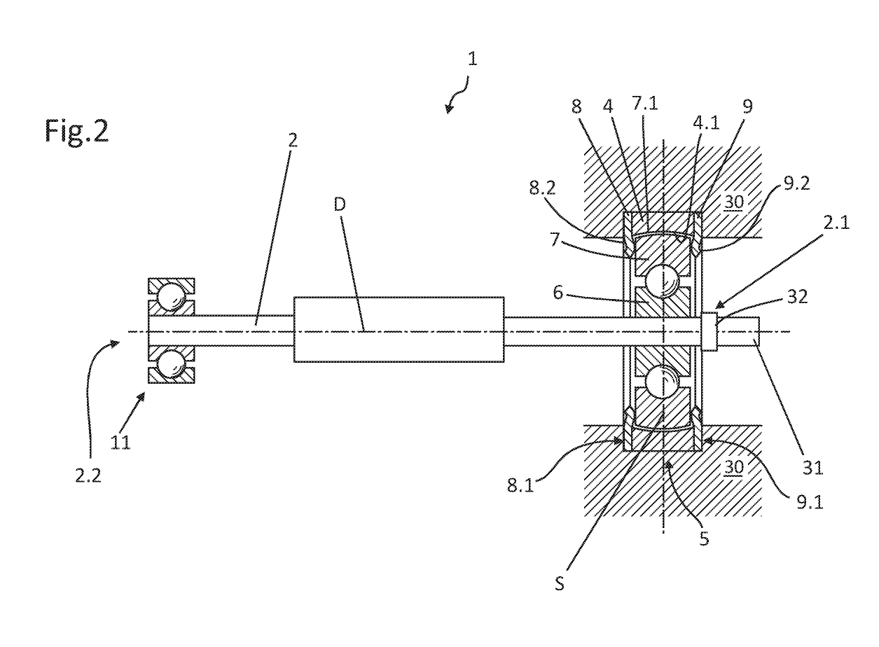

FIGS. 1 and 2 illustrate, in a partial cross-section depiction, a first embodiment of a gear unit 1 according to the invention, used for example in a power steering system of a car.

The gear unit 1 includes a worm gear shaft 2 rotatably mounted about a rotation axis D, and a worm gear wheel 3, like the worm gear shaft 2, rotatably mounted relative to a housing 30. The rotation axis D extending in and corresponding to an axial direction. Although shown as one piece, the housing 30 may include several pieces rigidly connected together. A worm screw 2.3 of the worm gear shaft cooperates with a gear ring 3.1 of the worm gear wheel 3. A clutch 32, indicated diagrammatically, connects a first end 2.1 of the worm gear shaft 3 to a drive shaft 31 of a servo motor, not shown.

A first ball bearing 5 and a pivot ring 4 mount the worm gear shaft 2 in the region of the first end 2.1 on the housing 30. The pivot ring 4 is generally secured stationary on the housing 30. The first ball bearing 5 includes an inner bearing ring 6 and an outer bearing ring 7. The two bearing rings 6, 7 are configured concentrically to the rotation axis D. The outer bearing ring 7 has a convex spherical outer face 7.1 received in a concave, also spherical, inner face 4.1 of the pivot ring 4. The first ball bearing 5 pivots about its center point inside the pivot ring 4. In particular, pivoting about a pivot axis S that intersects the rotation axis D and runs perpendicular thereto.

A second ball bearing 11, connected to a spring 33, mounts the worm gear shaft 2 at a second end 2.2, opposite the first end 2.1, on the housing 30. The spring 33 pretensions the worm gear shaft 2 against the worm gear wheel 3. In connection with the pivotable mounting of the worm gear shaft 2, the pretensioned mounting provides for an optimal engagement between the worm gear shaft 2 and the worm gear wheel 3.

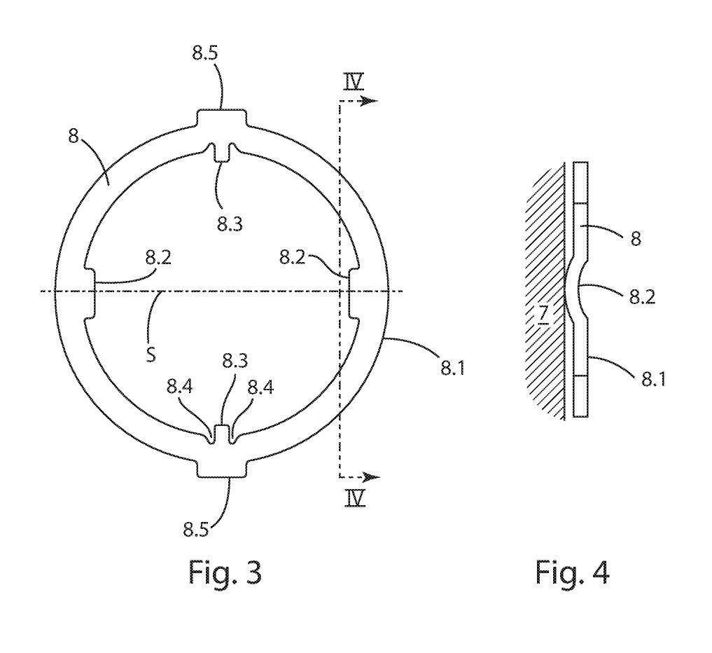

Axially, on both sides of the pivot ring 4, two circular ring-like spring elements 8, 9 are arranged, spring element 8 is shown in FIG. 3, in isolation together with the first ball bearing 5. The two spring elements 8, 9 are made of spring steel and may be produced from a sheet by punching and embossing. They are each received axially between the housing 30 and the pivot ring 4, so that an interference fit exists in this direction. In particular, each spring element 8, 9 is supported axially on the housing 30 in a direction facing away from the pivot ring 4. FIGS. 2, 3 and 4 illustrate each spring element 8, 9 having two contact portions 8.2, 9.2 axially engaging the outer bearing ring 7.

FIG. 3, depicts the spring element 8 in isolation, it should be understood that the corresponding spring element 9 is similar if not identical to spring element 8. Accordingly, the description of spring element 9 would be the same as the following description of spring element 8. The contact portions 8.2 protrude radially inward from a ring portion 8.1 extending within a plane perpendicular to the rotation axis D. As illustrated in FIG. 2 and the cross-section depiction in FIG. 4 which, in addition to the spring element 8, also shows diagrammatically the outer bearing ring 7, the contact portions 8.2 are axially extending bulges in the spring steel sheet protruding axially, in the direction of the rotation axis D, relative to the ring portion 8.1. The contact portions 8.2 are arranged opposite each other in the direction of the pivot axis S. Each contact portion 8.2 loads the outer bearing ring 7 locally and, to a certain extent, provides a pretension force. The contact portions 8.2 reinforce and define/control the stiffness of the first ball bearing 5 against displacement in the axial direction, wherein the stiffness against pivot movement remain substantially unaffected. Also, the contact portions 8.2 define the pivot axis S, wherein the ring portion 8.1 is arranged outside the pivot radius of the ball bearing 5.

Two spring elements 8, 9 are placed adjacent the bearing 5 to set the stiffness or elasticity against pivot movement of the bearing 5 about the pivot axis S. As illustrated, the spring element 8, 9 includes two spring portions 8.3, 9.3 offset from the contact portions 8.2, 9.2 by 90° along the ring portion 8.1, 9.1. They are thus arranged symmetrically on both sides of the pivot axis S. The spring portions 8.3, 9.3 protrude radially inward relative to the ring portion 8.1, wherein, as shown in FIG. 1, they are tilted slightly in the axial direction towards the outer bearing ring 7. The spring portions 8.3, 9.3 engage or contact on the outer bearing ring 7 and depending upon the degree of tilt in the axial direction exert a pretension preloaded force against the outer bearing ring 7. Even if the spring portions 8.3, 9.3 do not exert an initial preloaded force or pretension against the outer bearing ring 7, pivot movement of the first ball bearing 5 leads to generation of a return torque or return force, caused by deflection of two of the total of four spring portions 8.3, 9.3.

To increase/control the elasticity of the spring portions 8.3, 9.3, notches 8.4 are provided adjacent to the spring portions 8.3, 9.3 on both sides thereof, the notches 8.4 extend radially outward into the ring portion 8.1, 9.1. The notches 8.4 may also be omitted. Each spring element 8, 9 includes a positioning lug 8.5, 9.5 protruding radially outward from the ring portion 8.1, 9.1 on an outside or outer edge or surface of the ring portion 8.1, 9.1 and opposite the respective notch 8.4, 9.4. The additional material of the positioning lug 8.5, 9.5 partially compensates for the material missing in the region of the notches 8.4, 9.4 and helps stabilize the structure of the spring element 8, 9 in this region. Each positioning lug 8.5, 9.5 is received in a complementary recess of the housing 30. The resulting interference fit fixes and rotationally positions each spring element 8, 9 relative to the housing 30 and also secures the position of the pivot axis S.

The gear unit 1 may be used in a motor vehicle, in particular private cars and commercial vehicles. In one example, the gear unit 1 may be a gear unit for a power steering system, although other applications are possible, for example, window lifters, electric seat adjustment mechanisms or other movable mechanisms.

The gear unit 1 has an axially extending, rotatably mounted worm gear shaft 2 rotatable about an axially extending rotation axis D. The axial direction of the rotation axis D defines the radial and tangential directions mentioned below. The worm gear shaft 2 normally intended to be coupled, directly or indirectly, to a drive shaft 31 of a servo motor extending approximately coaxially. A clutch or clutch arrangement 32 transmits a torque from the driveshaft 31 to the worm gear shaft 2. In the operating state, the worm gear shaft 2 cooperates with a worm gear wheel 3 also forming part of the gear unit 1. Normally, this steps down the rotary motion of the drive shaft 31.

A rotary bearing 5 mounts the worm gear shaft 2 on a housing 30. The rotary bearing 5 having a spherical outer face 7.1 and pivotable about a pivot axis S. The spherical outer face 7.1 received in and complementary to a spherical inner face 4.1 of the stationary pivot ring 4. The housing 30 forming a normally stationary reference frame relative to the vehicle, by which the relative positions of the movable gear components are at least partially defined. The housing 30 may be made of one piece or be multipiece construction. It may be configured open to a varying extent, in which case it could also be described as a “frame” or similar. It is also possible that the gear components mentioned here, where applicable together with further gear components, are largely surrounded by the housing 30. As disclosed herein, worm gear shaft 2 pivots relative to the housing 30 in part due to the pivotable rotary bearing 5.

The pivotable rotary bearing 5 includes an outer bearing ring 7 having a spherical outer face 7.1 arranged in a stationary pivot ring 4. The spherical outer face 7.1 is formed convex, in the manner of a ball portion, while the pivot ring 4 has an inner face 4.1 that is also spherical, but formed concave. A degree of play is present between the respective stationary pivot ring inner face 4.1 and the outer bearing ring outer face 7.1. The pivot ring 4 arranged stationarily, for example fixed in position relative to the housing 30. Alternatively, the pivot ring 4 may also form part of a multipiece housing 30. In principle, structures are also conceivable in which the pivot ring 4 is configured integrally with a larger component and to this extent is mainly defined by the annular inner face 4.1. Since the outer face 7.1 of outer bearing ring 7 the rotary bearing 5 slides over the inner face 4.1 of the pivot ring 4, the rotary bearing 5 is pivotable relative to the pivot ring 4. The pivot axis extent through the center point of a virtual ball corresponding to the spherical outer face 7.1. The pivot axis S may extend perpendicular to the rotation axis D. Normally, it intersects the rotation axis D, but can be offset thereto.

Normally, the pivotable rotary bearing 5 is arranged on one side of the worm gear wheel 3, while the worm gear shaft 2 on the other side is mounted by a loose rotary bearing 11 pretensioned or loaded by a pretension element, seen generally at 33, such that the worm gear shaft 2 is pretensioned against the worm gear wheel 3. The loading may take place via an elastic pretension element arranged between the housing 30 and the loose rotary bearing 11. The pretension of the rotary bearing 5 defines a pretension of the worm gear shaft 2 in the direction towards the worm gear wheel 3. The corresponding pretension insures engagement between the worm gear shaft 2 and the worm gear wheel 3, wherein a corresponding pretension element 33, because of its elastic properties, may simultaneously allow a degree of deflection of the worm gear shaft 2, whereby the friction forces between the worm gear shaft 2 and the worm gear wheel 3 may be limited. The rotary bearings are normally roller bearings, in particular ball bearings. In some cases, a rotary bearing may also be configured as a plain bearing.

As shown, the gear unit 1 includes a spring element 8, 9 running tangentially or circumferentially, at least partially, around the rotation axis D and supported in the axial direction on one side on the housing 30 and on the other side on the rotary bearing 5. The spring element 8, 9 having two axially protruding contact portions 8.2, 9.2 oriented opposite each other in the direction of the pivot axis S. The spring element 8, 9, described in general as annular or at least as a ring portion, is arranged at least partially peripherally to the rotation axis D. As the term “spring element” implies, the element is at least partially elastic. The spring element 8, 9 rests on one side in the axial direction on the housing 30, including the possibility that the support is provided indirectly by an interposed component. The support is provided in the axial direction, meaning that forces may be transmitted in at least the axial direction. Support may also be provided in the radial direction and/or in the tangential direction.

The spring element 8, 9 is supported with the contact portions 8.2, 9.2 on the rotary bearing 5 in the axial direction. The contact portions 8.2, 9.2 protrude in the axial direction and may be referred to as protrusions. If the rotary bearing 5 is a roller bearing with an outer bearing ring 7 and an inner bearing ring 6, the spring element 8, 9 is supported with the contact portions 8.2, 9.2 on the outer bearing ring 7. As a whole however, a force flow path exists from the housing 30 via the spring element 8, 9 with the contact portions 8.2, 9.2 to the rotary bearing 5. The contact portions 8.2, 9.2 lie opposite each other in the direction of the pivot axis S, whereby they form a contact region running in the direction of the pivot axis S between the spring element 8, 9 and the rotary bearing 5. Preferably, each contact portion 8.2, 9.2 is restricted to a relatively narrow angular region about the rotation axis D, e.g. at most 20° or at most 10°.

Because the spring element 8, 9 is, in an exemplary embodiment, an elastomeric member supported locally on the rotary bearing 5, there is an axial pretension of the pivotable rotary bearing 5 that sets or establishes the axial elasticity or stiffness of the system. Also, the pivotable rotary bearing 5 is fixed relatively firmly in the region of the contact portions 8.2, 9.2, whereas it can move more easily in the other regions. The contact portions 8.2, 9.2 define the pivot axis S wherein pivoting about an axis significantly offset relative to the connecting line of the contact portions 8.2, 9.2 is limited. The actual pivot axis may however deviate slightly from the position of the contact portions because of the axial extension of the rotary bearing. Whereas at least the contact portions must be arranged axially relative to the rotary bearing 5, embodiments are conceivable in which other parts of the spring element 8, 9 are arranged not axially but e.g. radially on the outside relative to the rotary bearing 5.

The spring element 8, 9 has a ring portion 8.1, 9.1 extending transversely to the axial direction and tangentially at least partially about the rotation axis D. The ring portion 8.1, 9.1 extends in a plane extending transversely to the axial direction and spanning the radial and tangential directions. The ring may be a closed ring extending fully around the rotation axis, formed fully peripherally, it is also conceivable that the ring portion 8.1, 9.1 is configured to be not closed. The ring portion 8.1, 9.1 may be concentric to the rotation axis D. In particular, the spring element 8, 9 may be supported with the ring portion on the housing 30. According to one embodiment, the spring element 8, 9 is supported in the axial direction on one side on the housing 30 and on the other side on the pivot ring 4. The ring portion 8.1, 9.1 may also be form fit between the housing 30 and the pivot ring 4.

In a further embodiment, on a side axially opposite the spring element 8, 9, the rotary bearing 5 may be supported on the housing 30 by a conventional cup spring. However, it is preferred that two spring elements 8, 9 support the rotary bearing 5 on axially opposite sides thereof, this sets the pivot axis and significantly improves the axial stiffness. Each spring element 8, 9 is supported on the housing 30 and with two contact portions 8.2, 9.2 on the rotary bearing 5. The directions of the forces exerted by the contact portions 8.2, 9.2 of the one and the other spring element 8, 9 on the rotary bearing, are opposite. The contact portions 8.2, 9.2 of the two spring elements 8, 9 are arranged on opposite sides of the rotary bearing 5 in the axial direction. To simplify production, the two spring elements 8, 9 may be configured identically and installed mirror-symmetrically to each other in the gear unit 1, so the contact portions 8.2, 9.2 of the two spring elements 8, 9 engage the rotary bearing 5 on opposite sides.

Preferably, at least one spring element 8, 9 is formed as a metal molding. The metal molding may in particular be made of spring steel. In this way, the spring element may be produced from a metal sheet with few forming and/or cutting steps. This production method is particularly suitable since the spring element may be configured substantially flat. As an alternative to production as a metal molding, it is conceivable to use a component of similar form made of fiber-reinforced plastic or spring steel wire.

The contact portions 8.2, 9.2 extend radially inward from the ring portion 8.1, 9.1. The ring portion 8.1, 9.1 is preferably arranged radially outside the pivot ring 4, wherein the ring portion 8.1, 9.1 is outside a pivot region of the rotary bearing 5, preventing the ring portion 8.1, 9.1 from obstructing or influencing the pivotability of the rotary bearing 5. The contact portions 8.2, 9.2, however, must come to rest on the rotary bearing 5 and therefore should extend radially inward into the region of the rotary bearing 5. When made from sheet metal, the contact portion 8.2, 9.2 could be formed as inwardly directed tabs or lugs starting from the inner circumferential surface or edge of the ring portion 8.1, 9.1.

The contact portions could be formed by bulges in a metal plate. Such bulges may be produced by simple forming of a metal plate, pressing, embossing or deep drawing, wherein the metal thickness only changes insignificantly. A bulge is formed on a side of the spring element 8, 9 facing the pivot bearing 5, while on the other side, facing away from the pivot bearing 5, a corresponding depression is formed.

In a further embodiment, the spring element 8, 9 includes a positioning element or lug 8.5 arranged radially on the outside or outer circumferential surface of the ring portion 8.1, 9.1 and limited in the tangential direction, for rotationally fixing the position of the spring element 8, 9 on the housing 30. Because of the positioning element 8.5, restricted tangentially to a specific angular region, the spring element 8, 9 is not rotationally symmetrical on the outside or outer circumferential surface. The positioning element 8.5 provides an interference fit in the tangential direction through a form fit with a matching or complementary structure on the side of the housing, preventing twisting or rotation relative to the housing 30. The positioning element 8.5 ensures that the position of the contact portions 8.2, 9.2 remains unchanged relative to the housing 30 and whereby the pivot axis S cannot change.

The positioning element 8.5 may be configured in widely varying ways. For example, it may take the form of at least one notch or recess in which a protrusion or similar present on the housing side engages. According to a preferred embodiment, at least one radially outwardly directed positioning lug 8.5 is configured as a positioning element. Such a positioning lug 8.5 may extend outward from a ring portion 8.1 as described above. In particular, two positioning lugs may be present that lie opposite each other. One advantage of such an outwardly directed positioning lug over a notch is that the structure of the spring element or the ring portion is not weakened thereby, which in some cases may have an advantageous effect on the spring properties.

The contact portions 8.2, 9.2 define the pivot axis S and the stiffness of the system in the axial direction. To influence a stiffness or elasticity against pivot movements, according to an additional embodiment, at least one spring element 8, 9 includes elastic spring portions 8.3, 9.3 arranged on different sides of the pivot axis S and extending radially inward from the ring portion 8.1, 9.1. During a pivot movement, the spring portions 8.3, 9.3 exert a return force or return torque on the rotary bearing 5. The spring portions 8.3, 9.3 may be formed integrally from the same sheet metal part as the ring portion 8.1, 9.1. According to one embodiment, the spring portions 8.3, 9.3 protrude axially relative to the ring portion 8.1, 9.1, to constantly engage the rotary bearing 5 and, in some cases, provide a pretensioned or predetermined force against the rotary bearing 5. Alternatively, an axial gap may exist between the spring portions 8.3, 9.3 and the rotary bearing 5, wherein the rotary bearing 5 only contacts the spring portions 8.3, 9.3 after a predetermined amount of or upon reaching a specific deflection. To achieve a return effect independently of the pivot direction, the spring portions 8.3, 9.3 are arranged on different sides of the pivot axis S. For example, precisely two spring portions 8.3, 9.3 may be provided that are opposite each other, offset by 180° along the ring portion 8.1, 9.1. The spring portions 8.3, 9.3 could also be offset by 90° to the contact portions 8.2, 9.2. More than two spring portions 8.3, 9.3 are also conceivable. In particular, the arrangement of the spring portions 8.3, 9.3 need not be symmetrical relative to the pivot axis S. It is even conceivable that a different elasticity can be deliberately set, depending on pivot direction, via an asymmetric arrangement of the spring portions 8.3, 9.3.

The elasticity of the individual spring portions 8.3, 9.3 can be influenced by various parameters, e.g. their material, thickness or tangential extension. According to one embodiment, the ring portion 8.1, 9.1, adjacent to a spring portion, 8.3, 9.3 has at least one notch 8.4 extending radially outwards from the inner circumferential surface of the ring portion 8.1, 9.1 to the outer circumferential surface of the ring portion 8.1, 9.1. Such a notch 8.4, to a certain extent, increases the radial length of the spring portion 8.3, 9.3 without it extending further radially inwards. In particular, such notches 8.4 may be present on both sides of and adjacent to the spring portion 8.3. In another embodiment, the positioning lug 8.5 as described above, may be arranged on an outer circumferential surface or side of the ring portion 8.1, 9.1 opposite at least one notch 8.4 wherein any local weakening of the spring portion 8.3, 9.3 by the at least one notch 8.4 is partially compensated by a strengthening by the positioning lug 8.5.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A gear unit for a motor vehicle comprising:
a housing;
a worm gear shaft rotatable about a rotation axis;
a rotary bearing mounting said worm gear shaft on said housing; and
a spring element between said bearing and said housing having a ring portion, two axially protruding contact portions opposite each other in the direction of a pivot axis, two spring portions, and a positioning element.

2. The gear unit of claim 1 wherein said two spring portions extend radially inward and contact said rotary bearing on axially opposing sides of said rotary bearing.

3. The gear unit of claim 1 wherein said spring element is formed as a metal molding from a metal sheet.

4. The gear unit of claim 1 wherein said contact portions extend radially inward from said ring portion, with said annular element positioned radially outside said rotary bearing.

5. The gear unit of claim 3 wherein the contact portions are formed by bulges in said metal sheet.

6. The gear unit of claim 1 wherein said positioning element is positioned radially on the outside of said ring portion.

7. The gear unit of claim 1 wherein at least one radially outwardly directed positioning lug is configured as said positioning element.

8. The gear unit of claim 1 wherein said spring portions are located on different sides of a pivot axis and extend radially inward from said ring portion.

9. The gear unit of claim 1 wherein the ring portion adjacent to a spring portion has at least one notch extending radially outward.

10. A gear unit for a motor vehicle comprising:
a housing;
a worm gear shaft rotatable about a rotation axis;
a pivot ring contacting said housing and having an inner face;
a rotary bearing mounting said worm gear shaft on said housing, said rotary bearing having an outer bearing ring having an outer face, said inner face of said pivot ring and said outer face of said outer bearing ring complimentary whereby said rotary bearing pivots in relation to pivot ring; and
a spring element positioned between said bearing and said housing having a ring portion including two contact portions defining a pivot axis extending between said contact portions wherein said contact portions extend radially inwardly from said ring portion, axially, in the direction of said rotation axis, and outwardly transverse to said pivot axis, said contact portions contacting said outer bearing ring of said rotary bearing; two spring portions, said spring portions diametrically opposite each other and positioned perpendicular to the pivot axis, said spring portions extending both radially inward and axially in the direction of said rotation axis, said spring portions contacting said outer bearing ring of said rotary bearing; and a positioning element said positioning element extending radially outward from said ring portion and contacting said housing.

11. The gear unit of claim 10 wherein said ring portion of said spring element is located radially outward of said pivot ring whereby said ring portion does not limit movement of said outer bearing ring.
